(19) United States
(12) Patent Application Publication
(10) Pub. No.: US 2011/0061275 A1
(43) Pub. Date: Mar. 17, 2011

(54) SYSTEM AND METHOD OF ADVERTISING AND ADVERTISEMENT DISPLAY DEVICE

(76) Inventor: José Alberto Ginebra Giudicelli, Santo Domingo (DO)

(21) Appl. No.: 12/872,825

(22) Filed: Aug. 31, 2010

(30) Foreign Application Priority Data
Dec. 11, 2007 (DO) D2007-0034

(51) Int. Cl. G09F 13/04

(52) U.S. Cl. 40/572; 40/541; 40/564

(57) ABSTRACT

A system and method of presenting “one-to-one” advertising within a parking spot and a corresponding parking block display device is presented. The system and method comprise an illuminated advertisement message displayed and directed toward an associated vehicle parking spot, wherein the message comprises indicia corresponding to and tailored toward an intended recipient expected to park a vehicle in the vehicle parking spot. Moreover, the display device may be in the form of a parking block or wheel stop and, in at least one embodiment, includes a housing structured to define an at least partially hollow interior portion. The display device may further comprise an illumination assembly structured and positioned so as to direct a path of light to the exterior of the housing at least partially through one or more display members bearing the message or advertisement.

### CLAIM OF PRIORITY

A claim of priority is hereby made to currently pending U.S. Design patent application having Ser. No. 29/308,326 filed on Jun. 10, 2008, which claims priority pursuant to 35 U.S.C. §119 to a Dominican Republic application for an industrial design having Serial No. D2007-0034 filed on Dec. 11, 2007, the contents of which are incorporated herein by reference in their entirety.

### BACKGROUND OF THE INVENTION

1. Field of the Invention

The present invention is generally directed to a system and method for presenting “one-to-one” advertising within a vehicle parking spot, and a corresponding advertisement display device cooperatively structured and configured for use as a parking block or wheel stop disposed in or proximate an end of one or more vehicle parking areas, parking spaces or parking spots. In particular, the “one-to-one” advertising, as used herein, refers to an advertising system, method and/or technique which uses an advertisement or other message that is directed, geared or tailored toward a specific, single, or small group of intended recipient(s) at any given time, for example, a driver (and its passengers) who are expected to park in a particular associated parking spot given the surrounding store(s), business(es), residence(s), college(s), school(s), etc. In contrast, billboards, commercials, newspaper and magazine prints, etc., represent advertising media, which at any particular time, is simultaneously directed to or read by a large group of people or recipients.

Moreover, the system, method and device of the present invention comprises at least one illuminated advertisement message displayed and directed toward an associated vehicle parking spot. The illuminated advertisement message is disposed on at least one corresponding and cooperatively structured advertisement display device preferably positioned at or proximate an end of the parking spot. In particular, the illuminated advertisement message comprises indicia, which is at least partially tailored toward an intended recipient, such as an individual who is expected to park his or her vehicle in the parking spot, depending upon, for example, the neighboring businesses, stores, residences, universities, stadiums, etc.

2. Description of the Related Art

Most commercial and residential buildings, structures, and locations comprise one or more large, open parking lots or parking garages which generally include a plurality of vehicle parking spaces or parking spots. Specifically, the plurality of parking spots are generally positioned and used to direct, maintain, define, or control desired spacing, orientation, and alignment of vehicles parked therein. Each one of the various parking spaces may comprise a parking block mounted or secured to the pavement or other parking surface, and disposed within the confines of the parking space, or at least near or proximate an end thereof. Oftentimes, opposing or facing parking spaces may share a single parking block disposed between them.

Either way, each parking space may comprise a parking block that generally comprises a bulky concrete slab or plastic block that is generally not aesthetically pleasing. In addition, oftentimes each one of the parking blocks may be individually marked with permanent black ink or paint, for instance, with an apartment number, “Guest,” home address, or employee name identifying the current, designated, and authorized owner of the corresponding parking spot. Additionally, it is common for a plurality of businesses or residences to share a single, common parking garage or parking lot, wherein each of the parking blocks disposed within the common parking lot may be marked with ink or paint so as to designate where a particular customer or resident for one of the businesses may park his or her vehicle.

Again, these parking blocks are not aesthetically pleasing, and do not grab the attention of drivers or passengers within the vehicles parking in the corresponding parking space or otherwise driving within a visible distance relative to the parking blocks. Ideally, parking blocks should be aesthetically pleasing, attention grabbing, and be capable of displaying a plurality of colors, indicia, etc. Such parking blocks would ideally comprise an internal illumination assembly structured to direct a path of light through one or more at least partially translucent or transparent display members connected to or supported by a housing. The display members and/or illumination assembly may be used to identify an authorized owner or customer who may utilize the parking space via one or more particular colors and/or indicia disposed on the display member, such as names, numbers, logos, pictures, drawings, etc.

It would also be ideal if the display devices comprise advertising indicia disposed thereon, which is visible, readable, and aesthetically pleasing via the use of an illumination assembly structured to direct a path of light though the display member(s).

### SUMMARY OF THE INVENTION

As described in greater detail hereinafter, the present invention is directed to a system and method for presenting “one-to-one” advertising within a vehicle parking spot, and a corresponding advertisement display device disposed in or proximate an end of one or more vehicle parking areas, parking spaces or parking spots. In particular, as will be described in greater detail below, the advertisement display device may but need not be constructed and/or positioned to function as a parking block or parking stop which is generally used to maintain, define, or control desired spacing, orientation, and/or alignment of one or more parked vehicles. Moreover, the parking block and/or advertisement display device of at least one embodiment includes a housing which is structured to define an at least partially hollow interior portion sufficiently dimensioned to contain or otherwise house certain operative features and structures therein. The housing of at least one embodiment comprises a substantially elongated configuration and is composed of an at least partially rigid and/or durable material cooperatively constructed in order to facilitate practice of the present invention in the intended manner.

In addition, and as will become apparent from the following detailed description, the display device of at least one of the various embodiments is also structured and configured to display one or more illuminated, back lit panels or display members. The display member(s) of at least one embodiment may comprise an LED panel, LCD panel, and/or other panel structured to display an illuminated message. In yet another embodiment, however, the display members may comprise a material that is structured to or capable of at least partially transmitting light therethrough, such as, for instance, from a position within the housing to a position exterior of the housing. Such embodiments of the display members may therefore be clear, smoked, fogged, stained, colored, etc. The display members may therefore be at least partially translucent or transparent, and may further bear indicia thereon in the form of ink, paint, etching, etc., including, but certainly not limited to, advertising indicia, an individual's name, a business name, picture(s), drawing(s), logo(s), etc.

In order to effectuate the back light, or illumination of the display members, the at least one embodiment of the parking block or advertisement display device comprises an illumination assembly disposed at least partially within the interior portion of the housing. The illumination assembly comprises at least one illumination source, such as one or more light bulbs, lamps, tubes, high-intensity discharge lamps, LED's, neon lamps, etc., disposed or mounted within the interior portion of the housing and cooperatively structured and positioned so as to direct a path of light to an exterior of the housing at least partially through the one or more display member(s). The illumination source may also comprise any one or more colors or shades, for instance via color filters, or one or more different colored illumination sources.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of the parking block display device as disclosed in accordance with at least one embodiment herein.

FIG. 2 is a front elevation view of the parking block display device illustrated in FIG. 1.

FIG. 3 is a left side elevation view of the parking block display device illustrated in FIGS. 1 and 2.

FIG. 4 is a top plan view of the parking block display device as disclosed in accordance with at least one embodiment of the present invention.

FIG. 5 is a bottom perspective view of the parking block display device as illustrated in FIG. 4.

FIG. 6 is a side interior elevation view of the parking block display device illustrated in FIGS. 4 and 5.

FIG. 7 is top view of at least one embodiment of the present invention disposed proximate an end of at least two parking spots.

FIG. 8 is a top view of at least one embodiment of the present invention disposed proximate and end of one parking spot.

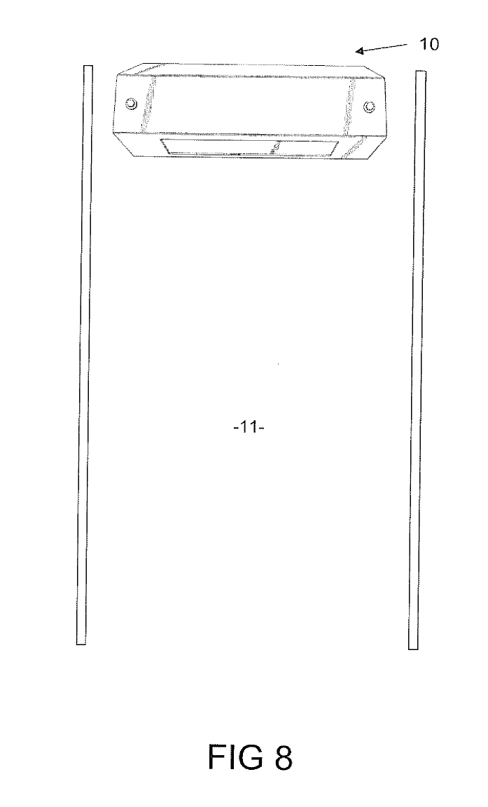

Like reference numerals refer to like parts throughout the several views of the drawings.

### DETAILED DESCRIPTION OF THE PREFERRED EMBODIMENT

The present invention is directed to a system and method for presenting “one-to-one” advertising within a vehicle parking spot, and a corresponding parking block and/or advertisement display device. As shown in the accompanying drawings, at least one embodiment of the advertisement display device is generally referenced as 10. In particular, the system and method comprises at least one illuminated message, such as an illuminated advertisement message, displayed and directed toward an associated vehicle parking spot 11. The illuminated message is disposed on at least one corresponding and cooperatively structured advertisement display device 10. In particular, and as will become apparent from the following discussion, the illuminated message may comprise a message or other indicia displayed on a display panel 30 which may comprise an LCD panel, a plurality of LEDs, and/or a back-lit or at least partially transparent or translucent panel structured to allow a path of light to pass therethrough.

Moreover, the illuminated message of at least one embodiment comprises indicia at least partially corresponding to and tailored toward an intended recipient expected to park a vehicle within the associated parking spot 11. For exemplary purposes only, depending upon the location of the parking spot 11, such as, at or near a school, shopping mall, stores, and other residences or businesses, the intended recipient may be defined as an individual or group of individuals who are expected to visit the neighboring or proximate locations. Accordingly, the illuminated message may be specifically tailored to target the intended recipient via “one-to-one” advertisement within a particular vehicle parking spot 11. Furthermore, as will become apparent from the following discussion, the illuminated advertisement message displayed on the advertisement display device 10 and/or display panel(s) 30 is interchangeable with different illuminated messages. For instance, the display panel 30 may be removed and replaced with a different display panel 30 bearing different indicia, or in the case where the illuminated message is digitally programmed or embedded within the display panel 30, the message or display panel may be reprogrammed or reconfigured to display the different or interchanged message.

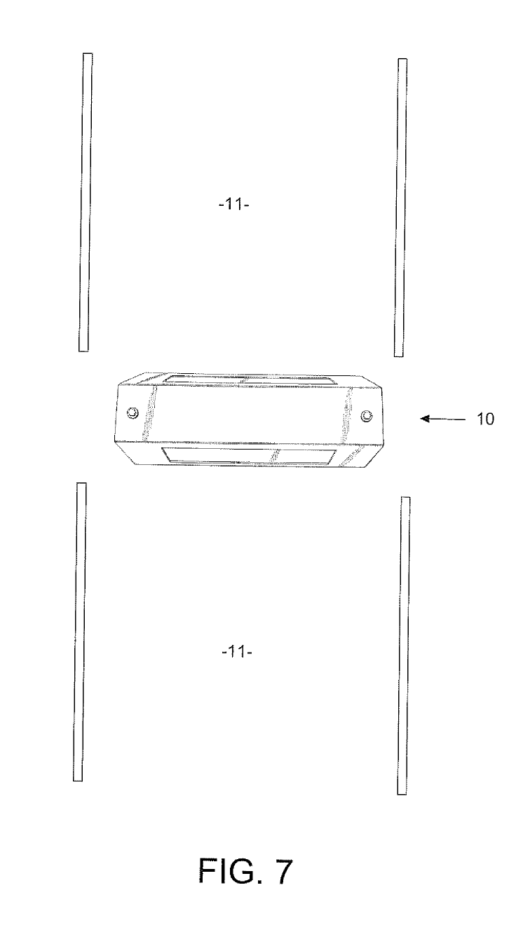

In addition, at least one embodiment of the system and method of the present invention comprises a plurality of illuminated messages, each being displayed and directed toward a different one of a plurality of vehicle parking spots 11. For example, the plurality of illuminated messages may be disposed on a single or common display device 10, as generally illustrated in FIG. 7. However, the system and method may comprise a plurality of display devices 10 each corresponding to a single or a pair of distinct vehicle parking spots 11.

Furthermore, the display device 10 of at least one embodiment of the present invention is cooperatively structured and configured for use as a parking block and/or wheel stop disposed in, and/or proximate an end of, one or more vehicle parking areas or other spaces 11 generally used to maintain, define, or control desired spacing, orientation, and/or alignment of a parked vehicle. In addition, and as generally mentioned above, the display device 10 is also structured and configured to display or otherwise exhibit or present one or more illuminated or back lit panels or display members, which may, in at least one embodiment, bear indicia thereon, including, but certainly not limited to, advertising indicia, an individual's name, a business name, picture(s), drawing(s), logo(s), etc.

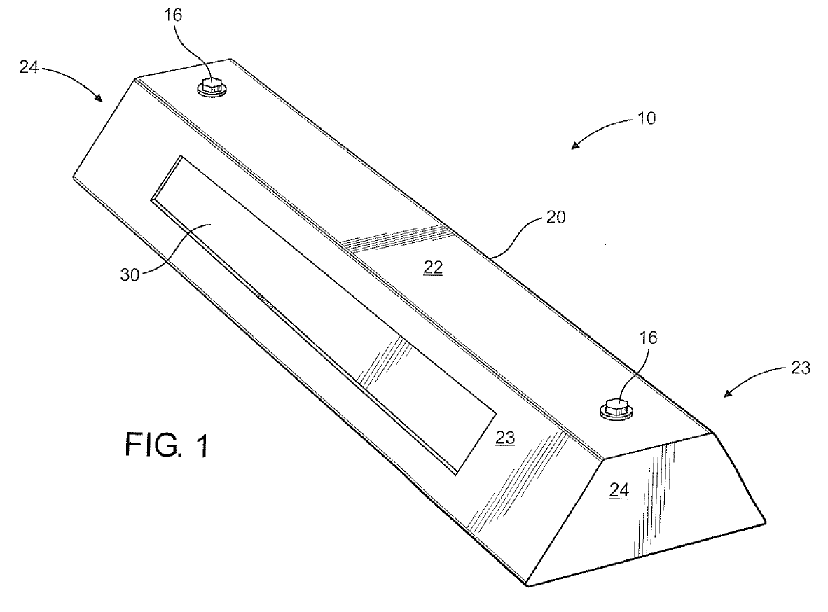

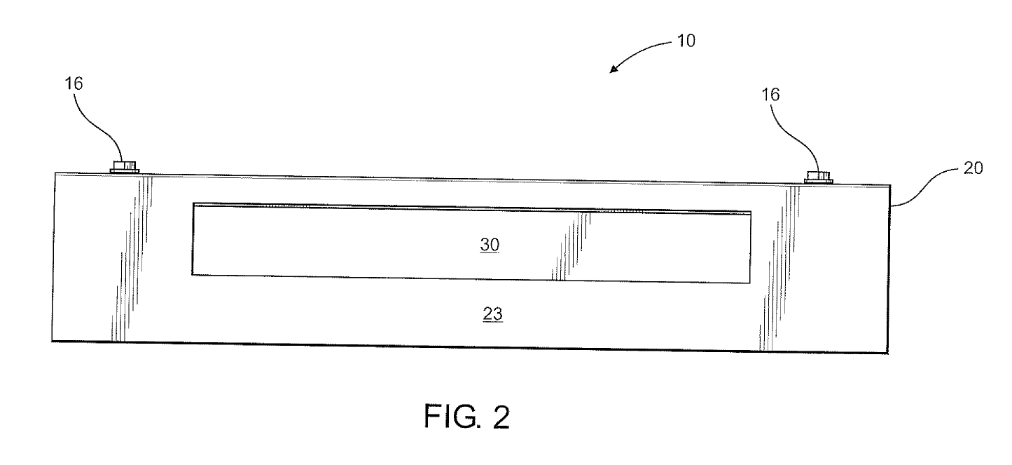

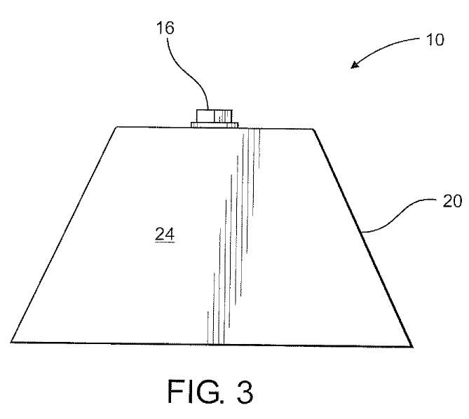

Moreover, as shown in the various Figures, and with particular reference to FIGS. 1-5, the parking block display device 10 includes a housing 20 comprising an at least partially hollow interior 12 sufficiently dimensioned to contain or otherwise house certain operative features and structures therein, as will be explained in greater detail below. The housing 20 of at least one embodiment comprises a substantially elongated configuration dimensioned to fit or be disposed within the lateral width of a particular associated vehicle parking area 11. The housing 20 is in no way, however, limited to such a configuration and may instead comprise virtually any length, width, or dimension which is structured to facilitate the practice of the present invention in the intended manner. Further, the housing 20 comprises an at least partially rigid and/or durable material cooperatively constructed in order to facilitate the intended purposes of the present invention described herein, and may include, but is certainly not limited to, concrete, metal, metal alloys, plastic, rubber, etc., or any combination thereof.

In addition, the housing 20 and/or the parking block display device 10 may be secured or anchored to a supporting surface, such as the ground, concrete, black top, mounting blocks, poles, or other stable and/or secure surface(s) or object(s) so as to maintain the display device 10 in an intended position or orientation. Accordingly, the present invention may, but need not necessarily comprise an attachment assembly 16, including, but not limited to, one or a plurality of attachment members, such as screws, bolts, washers, or other mechanisms or devices structured to either fixedly or removably secure the display device 10 in its intended and operative orientation within the vehicle parking area.

Furthermore, the parking block display device 10 of at least one embodiment comprises at least one or more faces or panels structured and disposed to at least partially define the housing 20 and/or the interior portion 12 thereof. For example, referring to FIG. 1, the display device 10 of at least one embodiment comprises a top face 22, at least two substantially opposing longitudinal faces 23, and at least two opposing end faces 24. As also illustrated in FIG. 1, at least one, but more practically both of the substantially opposing longitudinal faces 23 are disposed in an at least partially upward angled configuration relative to the ground or supporting surface so as to enhance the visual display or recognition of the present invention.

Furthermore, and still referring to FIG. 1, when the parking block display device 10 of the present invention is disposed in an operative orientation, e.g., disposed in an overlying or secured relation with the surface of the vehicle parking area 11, the plurality of faces 22, 23, 24 of the housing 20 are structured to at least substantially close off and thereby isolate the interior portion 12 from the outer elements such as the weather and other conditions and debris. However, it is contemplated that the housing 20 may comprise one or more open ends or other exposed portions thereof. For instance, the display device 10 of at least one embodiment may have at least partially open end faces 24 thereby at least partially exposing the interior portion 12.

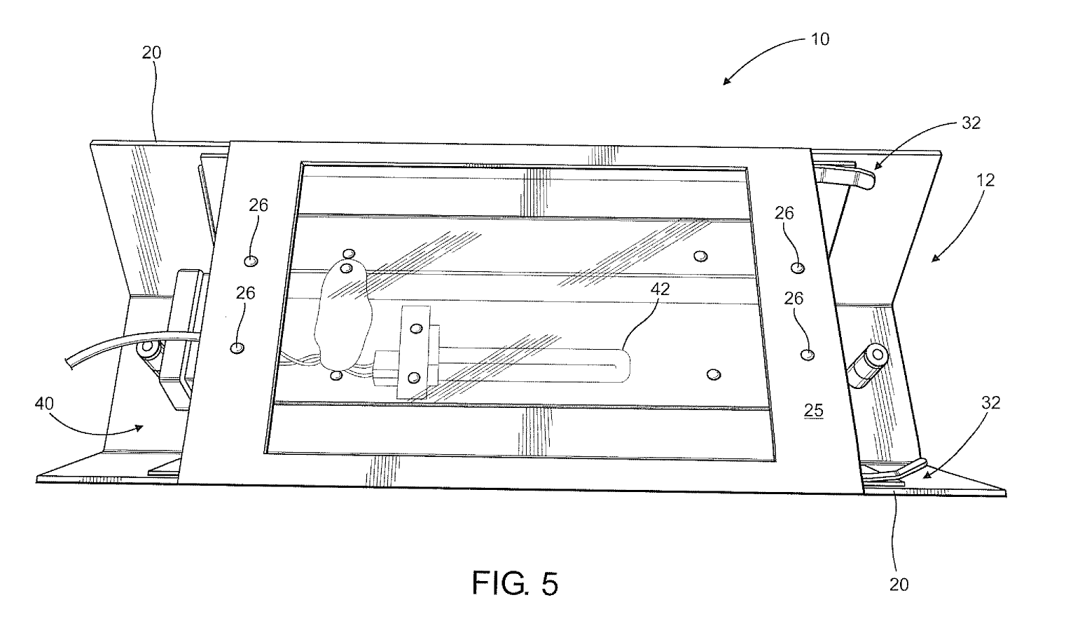

Moreover, as best illustrated in FIG. 5, at least one embodiment of the present invention comprises a bottom face 25 which is structured to be operatively disposed in a confronting and/or overlying relation with the surface of the vehicle parking area. The bottom face 25 may comprise one or more apertures, holes, or other structures 26 to facilitate the securing or attaching of one or more internal components of the present invention, such as the illumination assembly 40, as will be discussed in greater detail below.

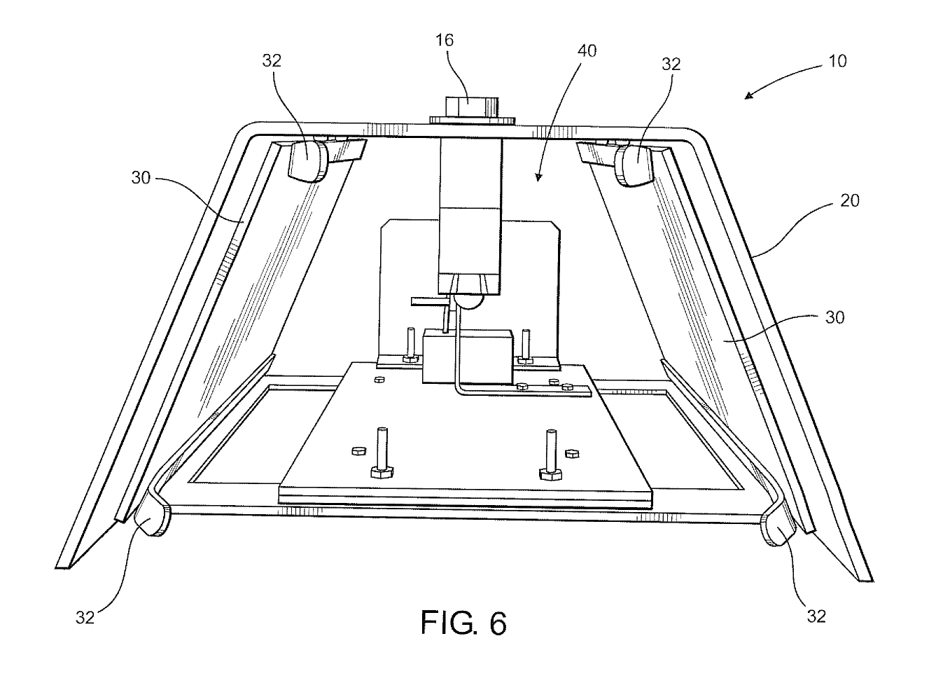

Furthermore, the parking block display device 10 of the various embodiments comprises at least one display member 30 disposed in an at least partially communicative relation with the interior portion 12 of the housing 20, and being visible from a position exterior to the housing 20. In particular, at least one of the plurality of faces 22, 23, 24 may comprise or be connected in a supporting relation with one or more display members 30. For instance, the display member 30 may, in at least one embodiment, encompass an entire face 22, 23, 24 of the housing 20, a portion of a face 22, 23, 24, and/or span across or onto several faces 22, 23, 24. As illustrated in the embodiments shown in FIGS. 1, 2, and 4, the display members 30 each comprise a portion of the corresponding face 23, and thus, the display member 30 may be connected to the corresponding face 23 in either a fixed, permanent, or removable relation. For instance, the display member 30 may be integrated, molded, or attached to the corresponding face 23 with adhesive or other agent. In at least one embodiment, however, as best illustrated in FIGS. 5 and 6, the display member(s) 30 may be removably connected to the housing and/or corresponding face(s) via a mounting assembly 32. The mounting assembly 32 includes, but is certainly not limited to, one or more clips, brackets, frames, screws, etc., extending around or connected to at least a portion of the display member 30, for instance, on the interior portion 12 of the housing 20, as illustrated in FIG. 6. The mounting assembly 32, as shown in FIGS. 5 and 6, comprises a plurality of elongated channels disposed at opposite longitudinal ends of the display member 30. Accordingly, the channels are dimensioned to slidingly receive the longitudinal ends of the display member 30 therein in a supporting and removable relation.

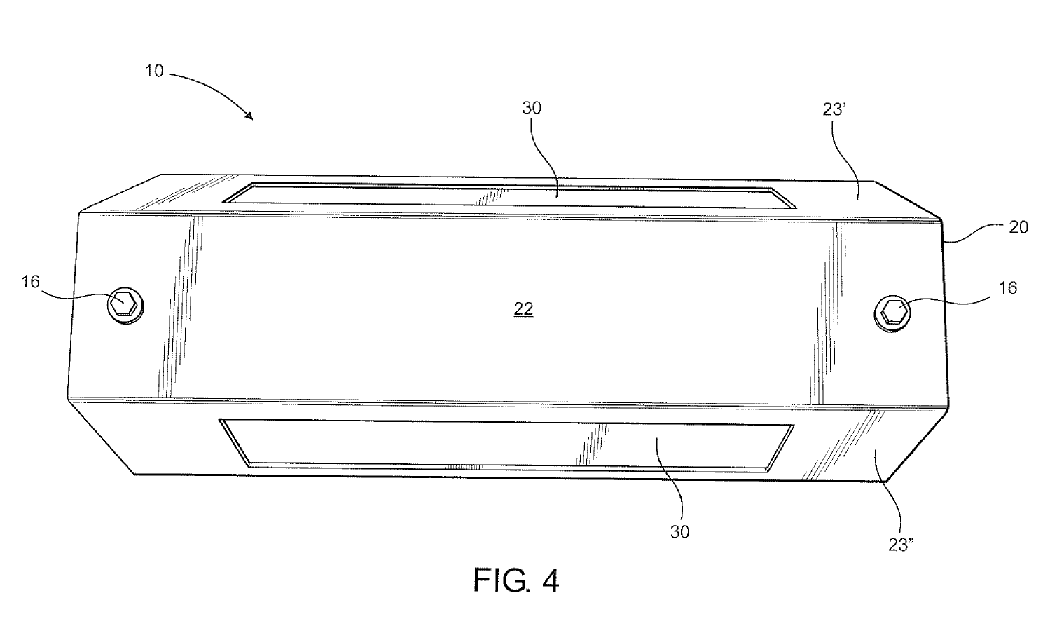

Moreover, as best shown in FIG. 4, the parking block display device of the present invention may comprise a plurality of display members 30, each connected to, and visible from an exterior of, the housing 20. In addition, at least two of the display members 30 may be disposed on substantially opposite facing sides of the housing 20, as illustrated at 23′ and 23″ in FIG. 4. Accordingly, a single parking block display device 10 may comprise multiple display members 30 each bearing the same or different indicia thereon and being visible from different positions. For instance, a single parking block display device 10 may be disposed between two facing parking spaces, wherein the single parking block display device 10 comprises at least two oppositely disposed display members 30 each visibly disposed from a direction positioned in a different one of the two facing parking spaces.

Furthermore, as best illustrated in FIGS. 1 and 6, the display member(s) 30 of at least one embodiment may be disposed in an angular orientation relative to the surface of the vehicle parking area (not shown), or otherwise relative to the supporting surface to which the parking block display device 10 of the present invention is secured or anchored. Such an angular orientation of the display member(s) 30 facilitates an optimum visual identification by a driver or operator of an approaching, parking, or parked vehicle.

Additionally, the parking block display device 10 of the various embodiments of the present invention comprises an illumination assembly 40 disposed at least partially within the interior portion 12 of the housing 20. In particular, the illumination assembly 40 comprises at least one illumination source 42 disposed or mounted within the interior portion 12 and structured and oriented to direct a path of light to an exterior of the housing 20 at least partially through the display member(s) 30.

The illumination assembly 40 comprises or is otherwise connected to a power source (not illustrated) so as to direct power or electricity to the illumination source 42. The power source may be disposed within the housing 20 and comprise one or more rechargeable and/or removable batteries or battery packs. However, the power source may instead or additionally be integrated with or disposed substantially external to the housing and may include various structures such as a conventional power socket or outlet, power generator, solar panels, etc. In addition, the present invention further comprises a power control assembly including one or more power switches, control boxes or circuitry, timers, daylight or nighttime sensors, etc., disposed within the interior portion 12 and/or external to the housing 20 and structured to selectively, manually, or automatically control the power to illumination assembly 40 and/or illumination source 42 so as to turn the illumination source 42 on and/or off.

Further, the illumination source(s) 42 of the various embodiments may comprise virtually any structures or devices capable of emitting a path of light, including, for example, incandescent light bulbs or lamps, gas-discharge lamps, fluorescent light bulbs, lamps, or tubes, high-intensity discharge lamps, light-emitting diodes (“LED's”), neon lamps, etc. The illumination source 42 may also comprise any one or more colors or shades, for instance via color filters, or one or more different colored sources.

Accordingly, the one or more display members 30 are disposed in an illuminating relation with the illuminating assembly 40 to the extent that the illumination assembly 40 is capable of directing a path of light at least partially through the display member 30 and to an exterior of the housing 20. As such, the display member 30 of at least one embodiment comprises a material that is capable of at least partially transmitting light there through from a position on the interior of the housing 20 to a position exterior to the housing 20. The display member 30 may thus comprise an at least partially translucent, transparent, tinted, colored, or stained material, including, but in no way limited to, plastic or glass.

Furthermore, the display member 30 of at least one embodiment comprises indicia disposed thereon, such as, for example, alphanumeric characters, symbols, logos, designs, photographs, drawings, etc., which are visible from an exterior position relating to the housing 20. The indicia may thus include advertising for any one or more businesses and/or identifying indicia associated with the particular vehicle parking spot. The indicia may therefore include an individual's name belonging to the parking spot and/or a business name indicating where certain customers for that particular business may park their vehicles. Moreover, in at least one embodiment the indicia is permanently etched, drawn, or embedded onto the associated display member 30, however, the indicia may be removably disposed via removable ink, stickers, etc., either disposed on the interior or exterior face of the display member 30.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A one-to-one advertising system comprising:
at least one illuminated advertisement message displayed and directed toward an associated vehicle parking spot,
said at least one illuminated advertisement message being disposed on at least one corresponding and cooperatively structured advertisement display device, and
wherein said illuminated advertisement message comprises indicia at least partially corresponding to and tailored toward an intended recipient expected to park a vehicle within the associated vehicle parking spot.

2. The system as recited in claim 1 wherein said illuminated advertisement message is interchangeable with a different illuminated advertisement message.

3. The system as recited in claim 1 further comprising a plurality of illuminated advertisement messages each being displayed and directed toward a different one of a plurality of vehicle parking spots.

4. The system as recited in claim 1 wherein said advertisement display device comprises a vehicle parking block.

5. The system as recited in claim 4 wherein said advertisement display device comprises a housing, an illumination assembly disposed within said housing, and at least one display member disposed in an illuminating relation with said illumination assembly; said illuminated advertisement message being disposed on said display member.

6. A method of providing one-to-one advertising within a vehicle parking spot, the method comprising:
disposing an illuminated advertisement message on an advertisement display device, the advertisement display device being associated with at least one corresponding vehicle parking spot, wherein the illuminated advertisement message is displayed and directed toward the corresponding vehicle parking spot, and
tailoring the illuminated advertisement message to comprise indicia associated with an intended recipient expected to park a vehicle within the associated vehicle parking spot.

7. The method as recited in claim 6 further comprising interchanging the illuminated advertisement message with a different illuminated advertising message comprising different indicia.

8. The method as recited in claim 6 further comprising defining the advertisement display device as comprising a vehicle parking stop disposed at or proximate an end of the corresponding vehicle parking spot.

9. The method as recited in claim 6 further comprising defining the advertisement display device as comprising a housing, an illumination assembly, and at least one display member connected to the housing wherein the illuminated advertisement message is disposed on the display member.

10. A parking block display device disposed at or proximate an end of an associated vehicle parking spot, said parking block display device comprising:
a housing,
said housing comprising at least one display member structured to display at least one illuminated message thereon, said illuminated message being visible from within the associated vehicle parking spot, and
wherein said illuminated message is structured to correspond to an intended recipient expected to park a vehicle within the associated vehicle parking spot,

11. The parking block display device as recited in claim 10 wherein said housing comprises an at least partially hollow interior portion.

12. The parking block display device as recited in claim 11 further comprising an illumination assembly disposed within said at least partially hollow interior portion of said housing.

13. The parking block display device as recited in claim 12 wherein said illumination assembly comprises an illumination source positioned to direct a path of light to an exterior of said housing at least partially through said display member.

14. The parking block display device as recited in claim 10 wherein said housing comprises a substantially elongated configuration.

15. The parking block display device as recited in claim 10 wherein said housing comprises a plurality of faces, said plurality of faces being structured and disposed to at least partially define an at least partially hollow interior portion.

16. The parking block display device as recited in claim 15 wherein at least one of said plurality of faces comprises said at least one display member.

17. The parking block display device as recited in claim 15 wherein said at least one display member is connected in a supporting relation said housing.

18. The parking block display device as recited in claim 10 wherein said at least one display member is disposed in an angular orientation relative to a surface of the vehicle parking spot.

19. The parking block display device as recited in claim 10 further comprising an attachment assembly structured and disposed to secure said housing to a surface of the vehicle parking spot.

20. The parking block display device as recited in claim 10 further comprising a plurality of display members, each connected to, and visible from an exterior of said housing.

21. The parking block display device as recited in claim 20 wherein at least two of said plurality of display members are disposed on substantially opposite facing sides of said housing.

22. The parking block display device as recited in claim 10 wherein said at least one illuminated message comprises advertising indicia.

23. The parking block display device as recited in claim 10 wherein said display member comprises a material capable of at least partially transmitting light there through.

24. The parking block display device as recited in claim 10 further comprising a plurality of at least two oppositely disposed display members.

25. The display device as recited in claim 27 further comprising a mounting assembly disposed within an interior portion of said housing and structured to dispose each of said plurality of display members in a supported relation with said housing.

26. The display device as recited in claim 28 wherein said mounting assembly is structured to slidingly and removably receive oppositely disposed longitudinal ends of each of said display members.
